(19) United States
(12) Patent Application Publication
(10) Pub. No.: US 2011/0208715 A1
(43) Pub. Date: Aug. 25, 2011

(54) AUTOMATICALLY MINING INTENTS OF A GROUP OF QUERIES

(75) Inventors: Xiaochuan Ni, Beijing (CN); Jian-Tao Sun, Beijing (CN); Gang Wang, Beijing (CN); Zheng Chen, Beijing (CN)

(73) Assignee: MICROSOFT CORPORATION, Redmond, WA (US)

(21) Appl. No.: 12/710,973

(22) Filed: Feb. 23, 2010

(51) Int. Cl. G06F 17/30

(52) U.S. Cl. 707/709; 707/E17.108

(57) ABSTRACT

The automatic search intent mining technique described herein pertains to a technique for mining search intent from a group of queries. The automatic search intent mining technique described herein automatically mines search intents from a group of queries. The technique leverages knowledge of query log data in order to determine search intent. The automatic search intent mining technique, in one embodiment, utilizes three kinds of information sources: Web page content, Web page structure and search engine query log data to mine intents for a group of queries. In one embodiment of the technique, the three data sources are used separately to mine candidate search intents for each of the three sources. The candidate search intents extracted from each of the three sources are then integrated to form the final search intents.

The search engine has become an indispensable tool for users to seek information from the World Wide Web (Web) or other database. Maximizing user satisfaction with search results received in response to a search query is always an important goal for a search engine. Understanding the intent behind a user's query, retrieving search results according to this intent, and organizing search result pages well can help a search engine improve user satisfaction. By discovering possible search intents (the intent or intention of the user when initiating a search), and associating these intents to a search query, search results can be improved.

Most users tend to use short queries when submitting a search query. Sometimes users use short queries because they do not know how to describe what they want to know. Other times users enter short queries because they are broadly interested in a subject and they are willing to browse related information. It is hard for a search engine to discern the intent of a user, especially for short queries.

Sometimes the user's intent can be manually inferred by a human being with prior knowledge of the subject being searched. Existing search engines usually manually define search intents, like “travel”, “person name”, and then classify queries to those predefined intents. This is called query-to-intent classification. This kind of approach is obviously limited by the breadth of intents which are manually defined by editors. For example, one search intent corresponding with a general concept, like “travel”, may cover a large number of queries but lose some specific aspects of a particular query, say “bellagio casino” which should be precisely associated with an accommodation intent. Defining many specific intents, however, involves much human effort and significantly increases the difficulty of classifying queries to those intents. Machine learning of user's search intent can be challenging. This is particularly true for short queries because the information inferable by a short query is very limited.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The automatic search intent mining technique described herein automatically mines search intents for a group of queries. In one embodiment, the technique is based on the assumption that a group of queries may share some common intents which can be automatically extracted. The technique leverages knowledge of query log data in order to determine search intent. Query log data is usually collected by search engine companies and includes recorded historical queries and associated search results submitted to a search engine by one or more users. A query log typically consists of a sequence of search actions, one per user query, each describing the following information: 1) terms that compose a query, 2) documents returned by the search engine, 3) documents that have been clicked, 4) the rank of those documents in the list of search results (usually based on relevancy), 5) date and time the search action/click took place and 6) an anonymous identifier for each session, among other data.

The automatic search intent mining technique, in one embodiment, utilizes three kinds of information sources: Web page content, Web page structure, and search engine query log data to mine intents for a group of queries. In one embodiment of the technique, the three data sources are used separately to mine candidate search intents for each of the three sources. The candidate search intents extracted from each of the three sources are then integrated to form the final search intents. These search intents can be used to obtain better search results for subsequent queries.

### DESCRIPTION OF THE DRAWINGS

The specific features, aspects, and advantages of the disclosure will become better understood with regard to the following description, appended claims, and accompanying drawings where:

FIG. 1 depicts a high level flow diagram of an exemplary embodiment of a process for employing the automatic search intent mining technique described herein.

FIG. 2 depicts a flow diagram of an exemplary embodiment of a process for employing the automatic search intent mining technique described herein wherein search intent candidates are obtained by using search content obtained for a group of search queries.

FIG. 3 depicts a flow diagram of an exemplary embodiment of a process for employing the automatic search intent mining technique described herein wherein search intent candidates are obtained by using Web page structure information obtained for a group of search queries.

FIG. 4 depicts a flow diagram of an exemplary embodiment of a process for employing the automatic search intent mining technique described herein wherein search intent candidates are obtained by using query log data to find queries and sub-queries.

FIG. 5 depicts a high level flow diagram of another exemplary embodiment of a process for employing the automatic search intent mining technique described herein.

FIG. 6 depicts a schematic of one exemplary architecture in which the automatic search intent mining technique described herein can be practiced.

FIG. 7 is a schematic of an exemplary computing device which can be used to practice the automatic search intent mining technique.

### DETAILED DESCRIPTION

In the following description of the automatic search intent mining technique, reference is made to the accompanying drawings, which form a part thereof, and which show by way of illustration examples by which the automatic search intent mining technique described herein may be practiced. It is to be understood that other embodiments may be utilized and structural changes may be made without departing from the scope of the claimed subject matter.

### 1.0 Automatic Search Intent Mining Technique

The following sections provide an overview of the automatic search intent mining technique, as well as exemplary processes and an architecture for employing the technique.

### 1.1 Overview of the Technique

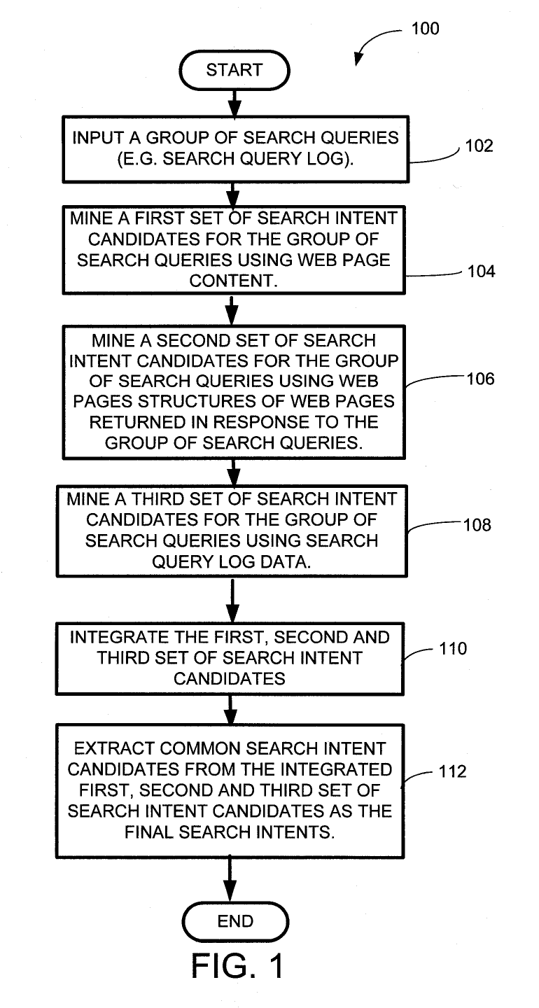

FIG. 1 provides a high level diagram of one exemplary process 100 for employing the automatic search intent mining technique. As shown in FIG. 1, the automatic search intent mining technique determines a set of search intents from multiple information sources and a group of input queries. For example, in one embodiment, the technique utilizes three kinds of information sources: Web page content, Web page structure and search engine query logs to mine candidate search intents for a group of queries for each of the three kinds of information sources. Typically, a query log includes a sequence of search actions, one per user query, each describing the following information: 1) terms that compose a query, 2) documents returned by the search engine, 3) documents that have been clicked (e.g., links in the documents have been followed or “clicked” by a user), 4) the rank of the documents in the list of search results, 5) date and time the search action/click took place and 6) an anonymous identifier for each session, among other data. The three information sources are used separately to mine candidate search intents for each of the three information sources. More specifically, a separate set of search intent candidates are obtained from Web page content, Web page structure and the usage data of the search engine query logs, respectively.

Once obtained, the three types of search intent candidates can then be integrated and common search intent candidates can be selected as the final search intents. These search intents can then, for example, be used to provide the user with additional or alternative search results or to focus a user's searching. Or the final search intents can be used to discover what subject matter users are searching for and to use such information to embed key phrases in Websites to attract users.

Thus, by discovering related information and related queries from the search query logs, the automatic search intent mining technique is able to leverage the knowledge of search engine users who have submitted these queries to help understand the input query.

It should be noted that although the technique can operate in fully automatic mode, it can also be used in a semi-automatic mode in one embodiment. For example, it can be employed with human editors to verify result quality. In this case, once the technique obtains a ranked list of intent candidates by applying the automatic search intent mining technique, human judges can be asked to check the candidates and to remove noisy/duplicate candidates or to add/delete some words from candidate phrases.

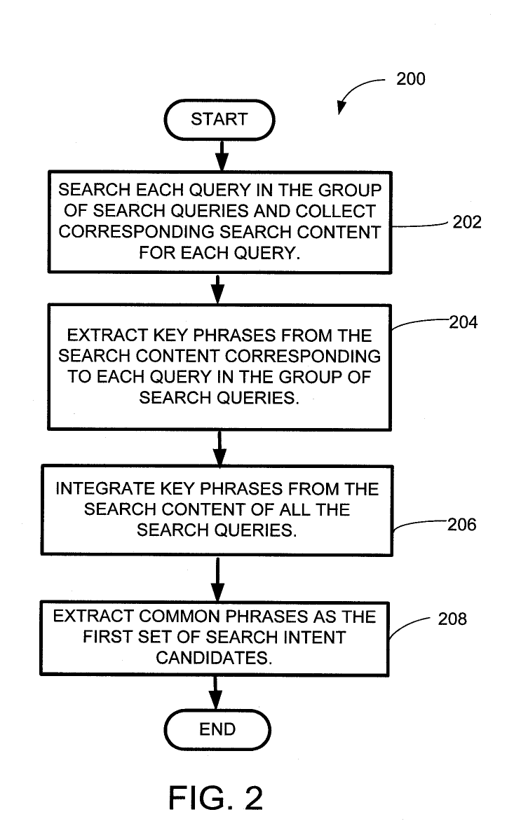

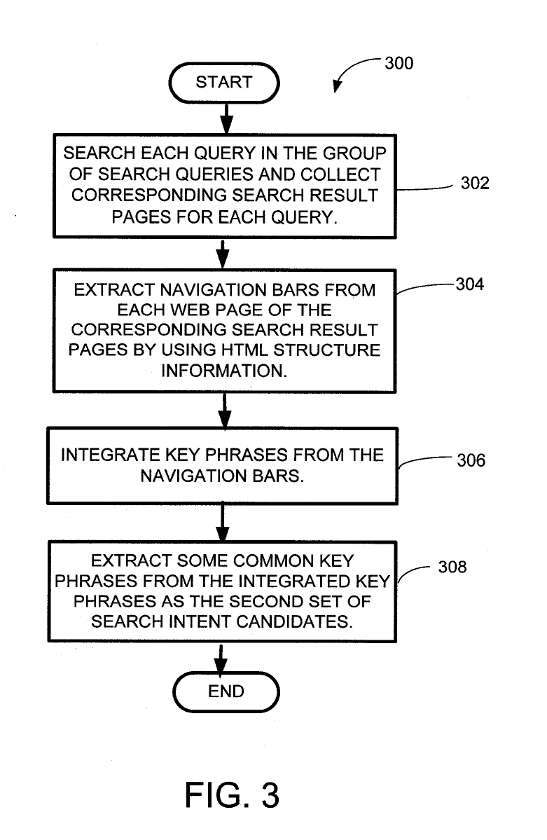

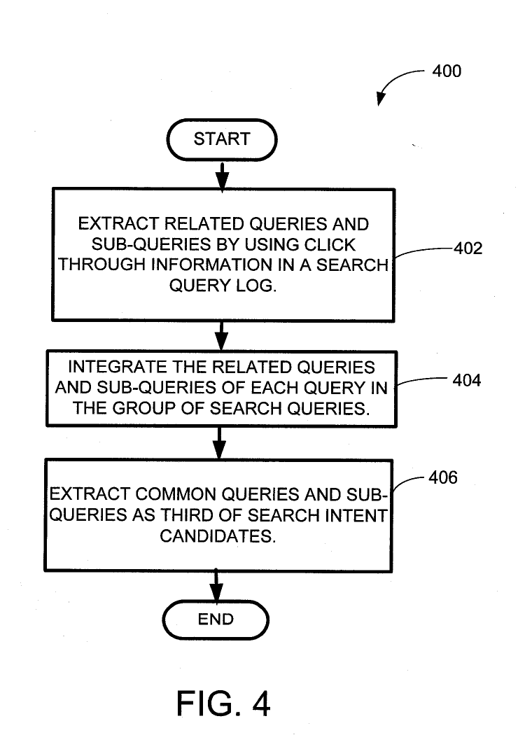

As shown in block 102, a group of search queries and associated query logs are input. A first set of search intent candidates for the group of search queries is mined by using Web page content of search results returned in response to the search queries, as shown in block 104. This generally involves extracting common concepts from the Web page content related to the group of input queries, and will be discussed in greater detail with respect to FIG. 2. As shown in block 106, a second set of search intent candidates for the group of search queries is mined by using Web structure for search results returned in response to the group of search queries. This generally involves extracting common information from Web pages returned in response to the group of input queries by using the Hypertext Markup Language (HTML) structure information of those pages, and will be discussed in greater detail with respect to FIG. 3. As shown in block 108, a third set of search intent candidates for the group of search queries is mined by using query log data. This generally involves extracting common queries or sub-queries from the search query log which are related to the queries in the input group of queries. This will be discussed in greater detail with respect to FIG. 4. The candidate search intents extracted from the three sources are integrated to form a set of integrated search intent candidates, as shown in block 110. The common search intent candidates are then extracted from the integrated search intent candidates as the final search intents (block 112). For example, the most common search intent candidates (e.g., key phrases) can be selected from the integrated search intents based on different criteria, such as, for example, the frequency with which they appear in the integrated search intent candidates. Also, candidates from different sources can be weighted differently when determining final search intents. Once obtained, these final search intents can be used to assist in obtaining better search results for subsequent queries, for example, or to gather data on what users are searching for.

An overview of one exemplary embodiment of the technique having been provided, additional details regarding the automatic search intent mining technique will be provided in the following paragraphs.

### 1.2 Mining Intents Using Web Page Content And Search Result Snippets

In one embodiment of the automatic search intent mining technique, mining intents using Web page content involves extracting common concepts from the content related to the queries in a group.

As shown in FIG. 2, one exemplary process 200 employing the automatic search intent mining technique operates as follows to extract search intent candidates from Web page content and search result snippets. As shown in block 202, each query in a search engine is found and the contents of the search results corresponding to each query (for example, search result snippets or search result pages associated with the search query) are collected (e.g., this can be extracted from the search query log data or by calling a search engine service). The technique treats the search snippets or Web pages as Web content related to the query. As shown in block 204, key phrases of Web content are extracted from the Web pages/search result snippets related to each query. In one embodiment the technique extracts all of the words/phrases in content, and then ranks the words/phrases according to their importance. The features that can be used to measure the importance of a word/phrase can include the number of occurrences, whether the word/phrase appears in a title, its position and the distance between its position and that of the query, and so on. As shown in block 206, these key phrases from each of the web pages or search snippets are integrated. The final key phrases for the Web content data source (e.g., search intent candidates) are extracted from the integrated key phrases based on the frequency with which they occur, as shown in block 208.

### 1.3 Mining Intents Using Web Page Structure

In one embodiment of the automatic search intent mining technique, mining intents using Web page structure involves extracting common information from the Web pages related to queries in a group by using the HTML structure information of those pages.

As shown in FIG. 3, one exemplary process 300 for mining intents using Web page structure employed by the automatic search intent mining technique is as follows. As shown in block 302, each query is input into a search engine and the search result pages are collected (e.g., this can be obtained from the query log data). In one embodiment of the technique, the top 10 search result pages for each query are collected. As shown in block 304, the navigation bars are extracted from each Web page by analyzing the DOM (Document Object Model) tree of the Web page. A navigation bar (also known as a links bar or link bar) is a sub region of a Web page that contains hypertext links in order to navigate between pages of a website. So, for example, the terms/phrases within the hypertext links are key phrases that can be used to indicate what information need the page/website satisfied for a user. Thus these key phrases are good candidates for indicating search intents. As shown in block 306, the phrases in navigation bars of all Web pages are integrated. Finally, as shown in block 308, some key phrases of the integrated phrases from the navigation bars are extracted as the candidate intents of the group of queries based on the Web page structure data. For example, these key phrases can be extracted based on how often they occur.

### 1.4 Mining Intents Using Search Query Log Data

In one embodiment of the automatic search intent mining technique, mining intents using search log data involves extracting common queries or sub-queries from a search query log which are related to the queries in a group.

FIG. 4 provides one exemplary process 400 for mining intents using search query log structure employed by the automatic search intent mining technique. As shown in block 402, queries and related sub-queries related to each query in the group are extracted by using the click through information in the search query log. For example, in one embodiment, related queries are extracted from Log data. For one query q₁, a search engine user may click one Web page (p) returned in response to the query. For another query q₂, the same Web page (p) may also be returned in response to this query and clicked by a user. In such case, the technique considers q₁ and q₂ as related queries to each other. For one query in a group (e.g., the original query), the technique may extract a set of related queries. Here the technique only keeps the queries which embrace the original query, i.e. the original query is the sub-string of those queries. After that, the related sub-queries are obtained by removing the original query from the selected related queries. Key phrases in all related sub-queries of all queries in the group and the group of queries are integrated, as shown in block 404. Key phrases of the common queries or sub-queries are extracted as the candidate intents of the group of queries, as shown in block 406. For example, these key phrases can be extracted based on how often they occur in the queries or sub-queries.

### 1.6 Integrating All the Candidate Intents

In one embodiment of the automatic search intent technique, the technique integrates the candidate intents of all information/data sources discussed above and extracts the most common search intent candidates (e.g., key phrases) as the final intents of the queries in the group. One embodiment of the technique integrates all of the intent candidates obtained using the aforementioned three data/information sources by integrating them based on frequency. In addition, the technique can associate different weights with frequency for different sources. For example, the technique can give weight 2 to the candidates mined from web page content, which means if one candidate occurs 1 time in Web content candidate set, the technique treats it as 1*2=2 times while performing the integration. In one embodiment, by default, the technique usually assigns a weight of 1 to all of the candidates from all sources. In one embodiment more weights are given to sources that are more trusted.

It should be noted that while selecting search intent candidates from all sources generally yields better results, it is possible to select search intent candidates from only two sources, or even one source. The results depend on quality of different data sources as well as the input queries. Additionally, even though only three specific information sources are discussed herein, one with ordinary skill in the art will realize that other types of information sources could also be integrated with the information sources discussed here to find the final search intents.

### 1.6 Alternate Embodiment

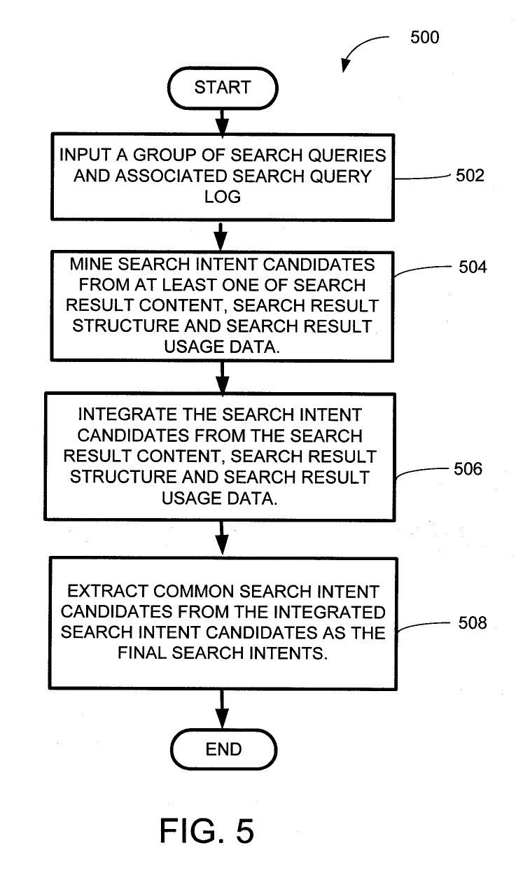

FIG. 5 provides a high level diagram of another exemplary process 500 for employing the automatic search intent mining technique. As shown in FIG. 5, in one embodiment, the automatic search intent mining technique utilizes at least one of three kinds of information sources: search result content, search result structure and search result usage data obtained from search engine query logs to mine candidate search intents for a group of queries from the three kinds of information/data sources. As previously discussed, a query log typically includes a sequence of search actions, one per user query, each describing the terms that compose a query, documents returned by the search engine, links in the documents have been followed or “clicked” by a user, the rank of the documents in the list of search results, date and time the search action/click took place and an anonymous identifier for each session, among other data. Each data source is used separately to mine candidate search intents for each given source that is used to determine search intent candidates.

As shown in block 502, a group of queries and associated search query log data is input. Then as shown in block 504, search intent candidates from at least one of search result content, search result structure and search result usage data are extracted. For example, extracting a set of search intent candidates by using Web page content for search results returned in response to the group of search queries generally involves extracting common concepts from the Web page content related to the group of input queries. Similarly, mining search intent candidates for the group of search queries by using Web structure for search results returned in response to the group of search queries generally involves extracting common information from the Web page content related to the group of input queries by using the HTML structure information of those pages. Additionally, mining search intent candidates for the group of search queries by using usage data from the query log data generally involves extracting common queries or sub-queries from the search query log which are related to the queries in the input group of queries. The candidate search intents extracted from any of the sources may be integrated to form a set of integrated search intent candidates, as shown in block 506. The most common search intent candidates are then extracted from the integrated search intent candidates as the final search intents (block 508). These final search intents can be used, for example, to assist in obtaining better search results for subsequent queries, for example, or to gather data on what users are searching for.

### 1.7 Exemplary Architecture

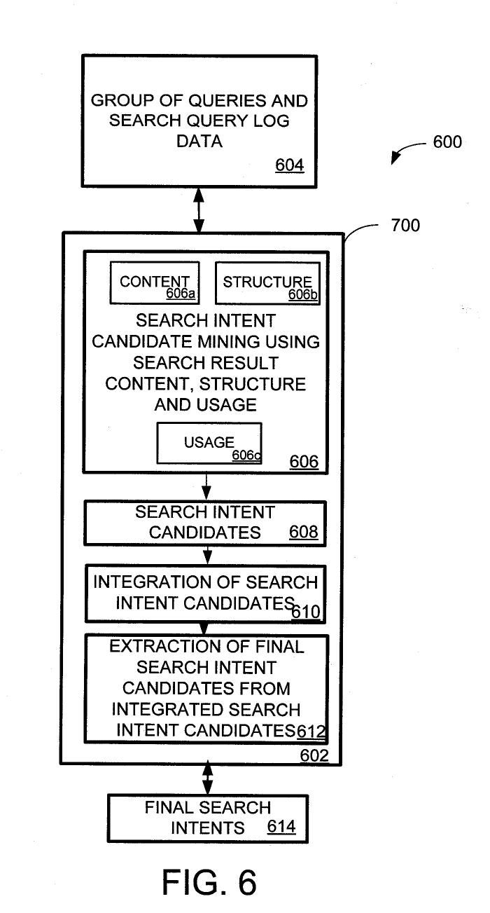

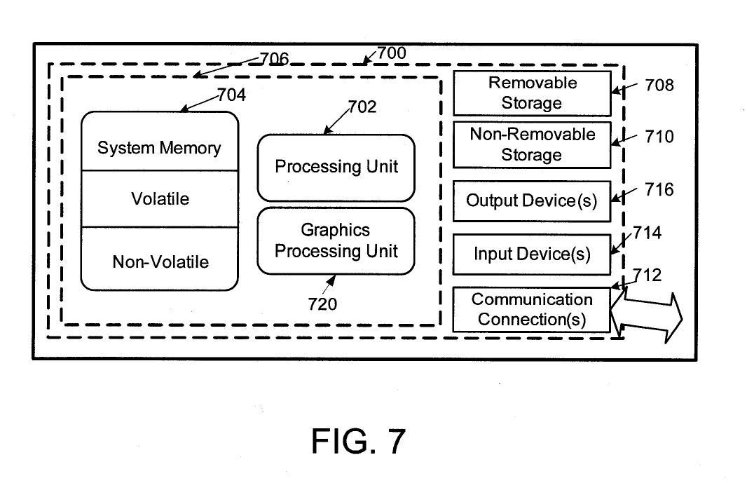

FIG. 6 provides a diagram of an exemplary architecture 600 for employing one embodiment of the automatic search intent mining technique. This architecture includes an automatic search intent computation module 602 which typically resides on a computing device 700, such as will be described in greater detail with respect to FIG. 7. Search query log data 604 (e.g., queries and associated search result Web pages/snippets, Web page structure info and search log data) are input into the automatic search intent computation module 602. Search intent candidate mining using search result content, search result page structure data and search result log query data is performed in a search intent candidate mining module 606. This module 606 includes search intent sub-modules 606a, 606b and 606c that calculate search intent candidates 608a, 608b and 608c for each of the aforementioned data sources. The search intent candidates 608 are then integrated in an integration module 610. The final search intents 614 are then extracted from the integrated search intent candidates in a search intent extraction module 612. In one embodiment of the automated search intent mining technique selects as the final search intents 614 the integrated search intent candidates that come up with the highest frequency. In one embodiment of the technique, search intent candidates from a specific data/information source are weighted more than search intent candidates from other sources.

### 2.0 The Computing Environment

The automatic search intent mining technique is designed to operate in a computing environment. The following description is intended to provide a brief, general description of a suitable computing environment in which the automatic search intent mining technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 7 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 7, an exemplary system for implementing the automatic search intent mining technique includes a computing device, such as computing device 700. In its most basic configuration, computing device 700 typically includes at least one processing unit 702 and memory 704. Depending on the exact configuration and type of computing device, memory 704 may be volatile (such as RAM), non-volatile (such as ROM, flash memory, etc.) or some combination of the two This most basic configuration is illustrated in FIG. 7 by dashed line 706. Additionally, device 700 may also have additional features/functionality. For example, device 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 700. Any such computer storage media may be part of device 700.

Device 700 also can contain communications connection(s) 712 that allow the device to communicate with other devices and networks. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 700 has a display device 722 and may have various input device(s) 714 such as a keyboard, mouse, pen, camera, touch input device, and so on. Output device(s) 716 devices such as a display, speakers, a printer, and so on may also be included. All of these devices are well known in the art and need not be discussed at length here.

The automatic search intent mining technique may be described in the general context of computer-executable instructions, such as program modules, being executed by a computing device. Generally, program modules include routines, programs, objects, components, data structures, and so on, that perform particular tasks or implement particular abstract data types. The automatic search intent mining technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for automatically mining search intent for a group of search queries, comprising:
using a computing device for:
inputting a group of search queries;
mining a first set of search intent candidates for the group of search queries by using Web page content of Web pages returned in response to the group of search queries;
mining a second set of search intent candidates for the group of queries by using Web page structures of Web pages returned in response to the group of search queries;
mining a third set of search intent candidates for the group of queries by using search query log data;
integrating the first, second and third set of search intent candidates; and
extracting the common search intent candidates from the integrated first, second and third set of search intent candidates as the final search intents of the group of search queries.

2. The computer-implemented process of claim 1, wherein mining the first set of search intent candidates further comprises:
searching each query in the group of search queries and collecting corresponding search content for each query;
extracting key phrases from the search content corresponding to each query in the group of search queries;
integrating the key phrases from the search content of all the search queries; and
extracting common key phrases from the integrated key phrases as the first set of search intent candidates.

3. The computer-implemented process of claim 1, wherein mining the second set of search intent candidates further comprises:
searching each query in the group of search queries and collecting corresponding search result pages for each query;
extracting navigation bars from each Web page of the corresponding search result pages by using HTML structure information;
integrating the key phrases from the navigation bars extracted from the Web pages of all the search queries; and
extracting common key phrases as the second set of search intent candidates.

4. The computer-implemented process of claim 3 wherein extracting navigation bars using the HTML structure information further comprises analyzing a Document Object Model (DOM) tree of each Web page of the corresponding search results.

5. The computer-implemented process of claim 1, wherein mining the third set of search intent candidates further comprises:
extracting related queries and sub-queries for each query in the group of search queries by using click through information in a search query log that generated each query in the group of queries;
integrating the related queries, sub-queries and each query in the group of search queries;
extracting common key phrases from the integrated related queries, sub-queries and queries as the third set of search intent candidates.

6. The computer-implemented process of claim 1, wherein extracting the common search intent candidates from the integrated first, second and third set of search intent candidates as the final search intents of the group of search queries, further comprises extracting the common key phrases from the integrated search intent candidates of the first, second and third search intent candidates as the final search intents of the group of queries.

7. The computer-implemented process of claim 6, wherein the common search intent candidates of the first, second and third search intent candidates are extracted as the final search intents of the group of queries based on the frequency of the common key phrases.

8. The computer-implemented process of claim 6, wherein the common search intent candidates of the first, second and third search intent candidates are weighted in extracting the final search intents of the group of queries.

9. A computer-implemented process for automatically mining search intent from a group of search queries, comprising:
using a computing device for:
inputting a grouping of queries and associated search query log data;
separately mining search intent candidates from at least one of search result content, search result structure and search result usage data;
integrating the search intent candidate candidates separately mined from the search result content, search result structure and search result usage data; and
extracting the most common search intent candidates from the integrated search intent candidates as the final search intents for the group of search queries.

10. The computer-implemented process of claim 9, wherein the search query log data further comprises a sequence of search actions, one per user query, each comprising:
terms that compose a query,
documents returned by the a engine,
links in the documents have been followed by a user,
a rank of the documents in the list of search results,
a date and time each search action or link activation took place,
and an anonymous identifier for each session.

11. The computer-implemented process of claim 9, wherein search result content further comprises content of Web page data.

12. The computer-implemented process of claim 9, wherein the search result content further comprises search engine snippets.

13. The computer-implemented process of claim 9, wherein the search result structure data further comprises Web page structure data.

14. The computer-implemented process of claim 9, wherein the search result structure data is determining by using a DOM tree of a Web page.

15. A system for automatically determining a user's search intent, comprising:
a general purpose computing device;
a computer program comprising program modules executable by the general purpose computing device, wherein the computing device is directed by the program modules of the computer program to,
mining search intent candidates for a group of search queries by using search result content data, search result usage data and search result structure data;
integrating the search intent candidates obtained by mining the search result content data, search result usage data and search result structure data of the group of search queries; and
extracting a set of final search intents by extracting common search intent candidates from the integrated search intent candidates.

16. The system of claim 15, further comprising a module for assigning different weights to different types of search intent candidates obtained by mining the search result content data, search result usage data and search result structure data of the group of search queries.

17. The system of claim 15, further comprising a module for using the final search intents to determine what type of information was searched for over a given time period.

18. The system of claim 15, further comprising a module for using the final search intents to generate key search words to embed in one or more files to be searched.

19. The system of claim 15, further comprising a module for using the final search intents to improve the relevance of subsequent search results returned in response to a new query.

20. The system of claim 15, wherein search result structure data is obtained by using navigational click through data of a user navigating hyperlinks on Web pages returned in search results.
